(19) United States
(12) Patent Application Publication
(10) Pub. No.: US 2015/0186073 A1
(43) Pub. Date: Jul. 2, 2015

(54) INTEGRATION OF A DEVICE WITH A STORAGE NETWORK

(71) Applicant: Lyve Minds, Inc., Cupertino, CA (US)

(72) Inventors: Mihnea Calin PACURARIU, Los Gatos, CA (US); Edward JUDALEVITCH, Santa Clara, CA (US); Jon CRISWELL, Saratoga, CA (US); Andreas VON SNEIDERN, San Jose, CA (US)

(73) Assignee: Lyve Minds, Inc., Cupertino, CA (US)

(21) Appl. No.: 14/144,366

(22) Filed: Dec. 30, 2013

(51) Int. Cl. G06F 3/06

(52) U.S. Cl. CPC G06F 3/0655; G06F 3/0608; G06F 3/067

(57) ABSTRACT

A method of integrating a device with a storage network may include generating metadata associated with image files generated by a camera of a device. The method may further include automatically transferring to a storage network the image files and the metadata based a status of the device. The status of the device may include on one or more of power consumption associated with transferring the image files and metadata, battery status of a battery of the device, available storage space on the device, available connectivity paths with the storage network, and a power supply mode of the device.

### FIELD

The embodiments discussed herein are related to integrating a device with a storage network.

### BACKGROUND

Digital video and photographs are increasingly ubiquitous and created by any number of cameras. The cameras may be integrated in multi-purpose devices such as tablet computers and mobile phones or may be standalone devices whose primary purpose is the creation of digital video and photographs. Often the management and transferring of the image files (e.g., video and picture files) generated by cameras may be cumbersome and inefficient.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment a method of integrating a device with a storage network may include generating metadata associated with image files generated by a camera of a device. The method may further include automatically transferring to a storage network the image files and the metadata based a status of the device. The status of the device may include on one or more of power consumption associated with transferring the image files and metadata, battery status of a battery of the device, available storage space on the device, available connectivity paths with the storage network, and a power supply mode of the device

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates a block diagram of an example storage system that includes a storage network with which a device including a camera may be integrated;

FIG. 2 illustrates an example electronic device that includes a camera and that may be integrated with a storage network;

FIG. 3 is a flowchart of an example method of integrating a device with a storage network.

### DESCRIPTION OF EMBODIMENTS

As described in further detail below, a device including a camera may include a capture agent configured to integrate the device with a storage network. The capture agent may be configured to register and authenticate the device with the storage network. The capture agent may also be configured to manage the transfer of image files (e.g., video and photos) generated by the device and camera of the device to the storage network. The capture agent may be configured to transfer the image files based on one or more factors associated with a status of the device such as, by way of example and not limitation, a battery status of a battery of the device, a power supply mode of the device, available storage space on the device, available network connectivity paths, and power consumption associated with transferring the image files. The capture agent may also enable or disable connectivity of the device with a communication network (which may enable connectivity to the storage network) based on one or more of the above-referenced factors. Accordingly, the capture agent may be configured to manage the transfer of image files to the storage network as well as connectivity with the storage network in an intelligent manner that may consider how the connectivity with the storage network and the transfer of the image files to the storage network may affect future use of the device.

In these or other embodiments, the capture agent may be configured to generate metadata associated with the image files. The metadata may include geolocation data, audio data, voice tag data, motion data, biological data, temperature data, time stamp, date stamp, user tag data, barometric pressure data, people data, and/or a fingerprint that may uniquely identify the image files and their related content. The storage network may use the metadata to organize the image files, allocate the image files throughout the storage network, and/or distribute the image files throughout the storage network in a particular manner. Therefore, the capture agent may be further configured to integrate the device with the storage network by generating metadata for the image files that facilitates the inclusion of the image files in the storage network.

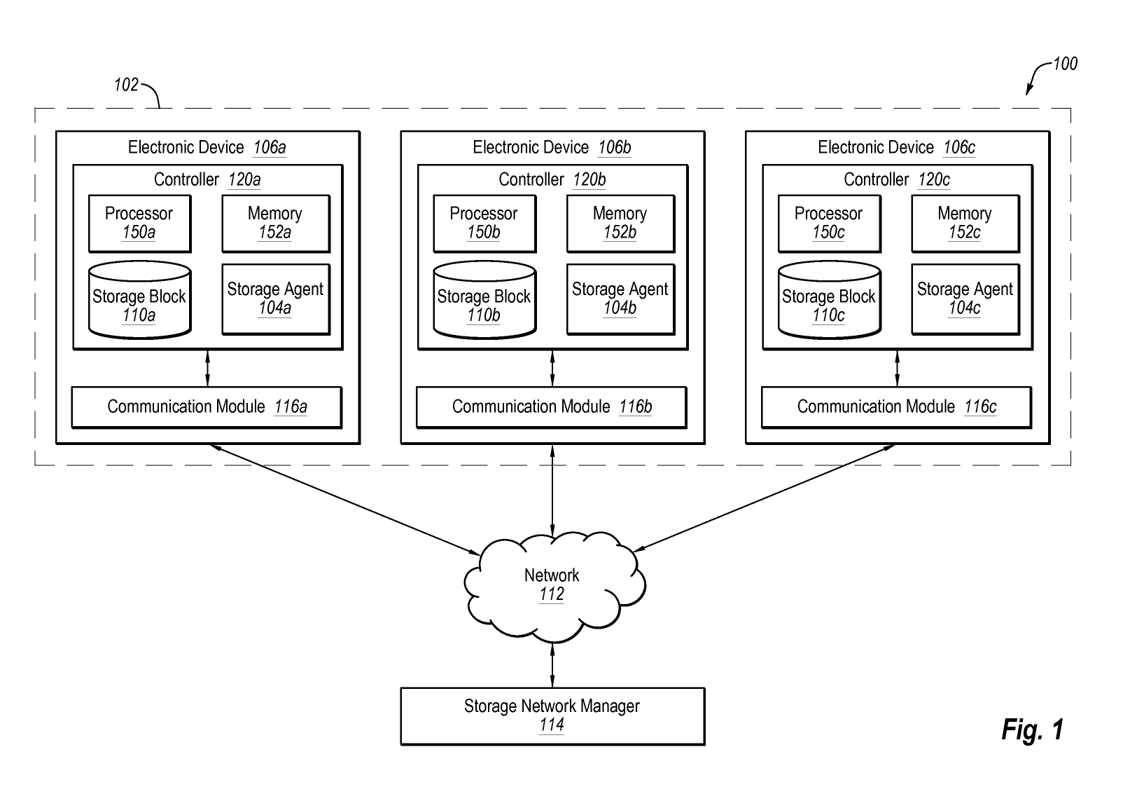

FIG. 1 illustrates a block diagram of an example storage system 100 that includes a storage network 102 with which a device including a camera may be integrated, according to at least one embodiment of the present disclosure. The storage network 102 may include one or more electronic devices 106 that may each include one or more storage blocks 106. The storage network 102 of the illustrated embodiment is depicted as including electronic devices 106a-106c (also referred to herein as “devices” 106), respectively, and the devices 106a-106c are depicted as each including a storage block 106. Although the storage system 100 is illustrated as including a single storage network 102 with three different devices 106 and storage blocks 110, associated therewith, the system 100 may include any number of storage networks 102 that may each include any number of devices 106 and storage blocks 110. Additionally, one or more of the devices 106 may include more than one storage block 110 in some embodiments.

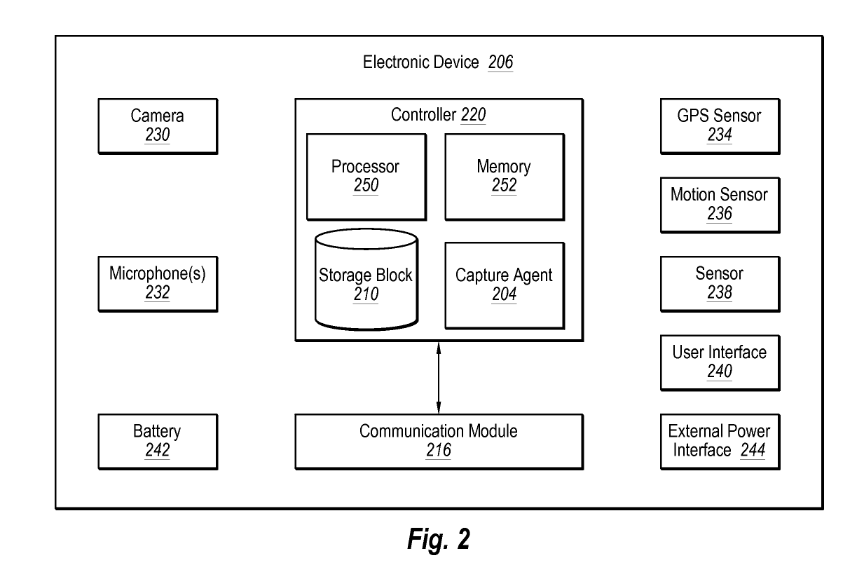

The devices 106 may include any electronic device that may generate and/or store data that may be integrated with the storage network 102. For example, the devices 106 may be any one of a cloud storage server, a mobile phone, a tablet computer, a desktop computer, a laptop computer, a camera, a personal digital assistant (PDA), a smartphone, a music player, a video player, an external hard drive, etc. FIG. 2 discussed below includes a specific instance in which a device 106 may include a camera.

In some embodiments, the storage system 100 may be configured to store, organize, and/or manage data files such as photos, videos, documents, etc. In some embodiments, the data files may be included in data objects that may also include metadata that may provide information about the data files. The term “data” in the present disclosure may refer to any suitable information that may be stored by the storage agents 104 and may include one or more data objects, data files, metadata, or any combination thereof.

The storage system 100 may be configured to organize and manage the data stored across the storage blocks 110 in an automated fashion that may reduce an amount of input required by a user. Additionally, the storage system 100 may be configured such that data stored on one storage block 110 included on a particular device 106 may be accessed and used by devices 106 other than the particular device 106. As such, the storage system 100 may facilitate organization of the data stored by the storage blocks 110 within the storage network 102 as well as provide access to the data, regardless of whether the data is stored on a storage block 110 local to a particular device 106.

In some embodiments, the devices 106 may each include a controller 120, which may each include a processor 150, memory 152, and a storage block 110. Additionally, the controllers 120 may each include one or more storage agents 104 that may be configured to manage the storage of data on the storage blocks 110 and the interaction of the devices 106 and storage blocks 110 with the storage network 102. By way of example, in the illustrated embodiment, the device 106a may include a controller 120a that includes a storage agent 104a, a processor 150a, memory 152a, and a storage block 110a; the device 106b may include a controller 120b that includes a storage agent 104b, a processor 150b, memory 152b, and a storage block 110b; and the device 106c may include a controller 120 that includes a storage agent 104c, a processor 150c, memory 152c, and a storage block 110c.

The processors 150 may include, for example, a microprocessor, microcontroller, digital signal processor (DSP), application-specific integrated circuit (ASIC), a Field-Programmable Gate Array (FPGA), or any other digital or analog circuitry configured to interpret and/or to execute program instructions and/or to process data. In some embodiments, the processors 150 may interpret and/or execute program instructions and/or process data stored in their associated memory 152 and/or one or more of the storage blocks 110.

The memories 152 may include any suitable computer-readable media configured to retain program instructions and/or data for a period of time. By way of example, and not limitation, such computer-readable media may include tangible and/or non-transitory computer-readable storage media, including Random Access Memory (RAM), Read-Only Memory (ROM), Electrically Erasable Programmable Read-Only Memory (EEPROM), Compact Disk Read-Only Memory (CD-ROM) or other optical disk storage, magnetic disk storage or other magnetic storage devices, flash memory devices (e.g., solid state memory devices), a specific molecular sequence (e.g., DNA or RNA), or any other storage medium which may be used to carry or store desired program code in the form of computer-executable instructions or data structures and which may be accessed by the processors 150. Combinations of the above may also be included within the scope of computer-readable media. Computer-executable instructions may include, for example, instructions and data that cause a general purpose computer, special purpose computer, or special purpose processing device (e.g., the processors 150) to perform a certain function or group of functions.

Although illustrated separately, in some embodiments, the storage agents 104 may be stored in the memories 152 as computer-readable instructions. As discussed further below, the storage system 100 may be configured to allocate data to the storage blocks 110 and to determine distribution strategies for the data allocated to the storage blocks 110. The storage agents 104 may be configured to carry out the allocation and distribution strategy for the data stored on the storage blocks 110.

The storage blocks 110 may also be any suitable computer-readable medium configured to store data. The storage blocks 110 may store data that may be substantially the same across different storage blocks 110 and may also store data that may only be found on the particular storage block 110. Although each device 106 is depicted as including a single storage block 110, the devices 106 may include any number of storage blocks 110 of any suitable type of computer-readable medium. For example, a device 106 may include a first storage block 110 that is a hard disk drive and a second storage block 110 that is a flash disk drive. Further, a storage block 110 may include more than one type of computer-readable medium. For example, a storage block 110 may include a hard disk drive and a flash drive. Additionally, the same storage block 110 may be associated with more than one device 106 depending on different implementations and configurations. For example, a storage block 110 may be a Universal Serial Bus (USB) storage device or a Secure Digital (SD) card that may be connected to different devices 106 at different times.

The devices 106 may each include a communication module 116 that may allow for communication of data between the storage agents 104, which may communicate data to and from their associated storage blocks 110. For example, the device 106a may include a communication module 116a communicatively coupled to the storage agent 104a; the device 106b may include a communication module 116b communicatively coupled to the storage agent 104b; and the device 106c may include a communication module 116c communicatively coupled to the storage agent 104c.

The communication modules 116 may provide any suitable form of communication capability between the storage agents 104 of different devices 106. By way of example and not limitation, the communication modules 116 may be configured to provide, via wired and/or wireless mechanisms, Internet connectivity, Local Area Network (LAN) connectivity, Wide Area Network (WAN) connectivity, Bluetooth connectivity, 3G connectivity, 4G connectivity, LTE connectivity, Wireless Fidelity (Wi-Fi) connectivity, Machine-to-Machine (M2M) connectivity, Device-to-Device (D2D) connectivity, any other suitable communication capability, or any suitable combination thereof.

In the illustrated embodiment, the communication modules 116 are depicted as providing connectivity between the storage agents 104 via a communication network 112 (referred to hereinafter as “network 112”). In some embodiments, the network 112 may include, either alone or in any suitable combination, the Internet, an Intranet, a local Wi-Fi network, a wireless LAN, a mobile network (e.g., a 3G, 4G, and/or LTE network), a LAN, a WAN, or any other suitable communication network. Although not expressly depicted in FIG. 1, in these and other embodiments, the communication modules 116 may provide direct connectivity between the storage agents 104 and the devices 106.

The communication of data between the storage agents 104 and storage blocks 110 may accordingly allow for the devices 106 to access and use data that may not be stored locally on their associated storage blocks 110. As such, the storage network 102, the devices 106, and the storage agents 104 may allow for storage of data while also allowing the devices 106 access to the stored data even when the data is not locally stored on the storage blocks 110 included in the particular devices 106.

The storage agents 104 may be configured to implement protocols associated with communicating data within the storage network 102 and the storage system 100. Additionally, some storage agents 104 may be configured to store only metadata associated with various data objects, while other storage agents 104 may be configured to store metadata and actual data files associated with the various data objects.

In some embodiments, to manage and provide information related to the storage of data in the storage network 102, a catalog of data stored by the storage agents 104 of the storage network 102 may be generated and managed for the storage network 102. The catalog may include a collection of all the metadata associated with the data stored in the storage network 102 and may include information such as which storage agents 104 may be locally storing particular data files and/or metadata. Accordingly, the catalog may be used to determine which storage agent 104 has certain data stored thereon. As such, the devices 106 may know from where to access data if the data is not stored locally on their respective storage agents 104. In some embodiments, the catalog may be stored by and synchronized between each of the storage agents 104.

In addition to communicating with each other, in some embodiments, the storage agents 104 may be configured to communicate with one or more storage network controllers that may be referred to individually or collectively as a storage network manager 114. The storage network manager 114 may act similar to a central service in a distributed storage system. The storage network manager 114 may be associated with a server operated by a third-party providing storage management services or may be locally stored on a device 106 owned and/or managed by a user whose data is stored in the storage network 102.

The storage network manager 114 may perform multiple functions in the storage system 100, such as coordinating actions of the storage agents 104. For example, the functions of the storage network manager 114 may include, but are not limited to, locating data files among the storage agents 104 of the storage network 102, coordinating synchronization of data between the storage agents 104, allocating storage of data on the storage agents 104, and coordinating distribution of the data to the storage agents 104.

In some embodiments, the storage network manager 114 may be included in one of the devices 106 with one of the storage agents 104 and, in other embodiments, the storage network manager 114 may be included in a device 106 that does not include a storage agent 104. Further, in some embodiments, the storage network manager 114 may perform operations such that the storage network manager 114 may act as and be a storage agent. For example, the storage network manager 114 may store data such as the catalog and/or other metadata associated with the storage network 102 and may synchronize this data with the storage agents 104 such that the storage network manager 114 may act as a storage agent with respect to such data.

In some embodiments the storage network manager 114 may communicate with the storage agents 104 via the network 112 (as illustrated in FIG. 1). The storage network manager 114 may also be configured to communicate with one or more of the storage agents 104 via a direct communication (not expressly illustrated in FIG. 1).

In some embodiments, the storage network manager 114 may be configured such that data files stored by the storage agents 104 are not stored on the storage network manager 114, but metadata related to the files and the catalog may be stored on the storage network manager 114 and the storage agents 104. In some embodiments, the storage network manager 114 may communicate instructions to the storage agents 104 regarding storage of the data such as the allocation and distribution of the data. The storage agents 104 may act in response to the instructions communicated from the storage network manager 114. Additionally, in some embodiments, the data communicated to the storage network manager 114 may be such that the storage network manager 114 may know information about the data files (e.g., size, type, unique identifiers, location, etc.) stored in the storage network 102, but may not know information about the actual content of the information stored in the storage network 102.

The storage agents 104 may locate data files within the storage network 102 according to metadata that may be stored on each of the storage agents 104. In some embodiments, such metadata may be stored as the catalog described above. For example, the storage agent 104a may locate a data file stored on the storage agent 104b using the catalog stored on the storage agent 104a. Some or all of the information for the storage agents 104 to locate data files stored on the storage network 102 may be communicated during synchronization between the storage agents 104 and/or a particular storage agent 104 and the storage network manager 114. Additionally or alternatively, the storage agents 104 may communicate with the storage network manager 114 to locate data files stored on the storage network 102.

Additionally, the storage network manager 114 may communicate with one or more of the storage agents 104 with unreliable or intermittent connectivity with other storage agents 104. As such, the storage network manager 114 may be configured to relay data received from one storage agent 104 to another storage agent 104 to maintain the communication of data between storage agents 104. For example, the storage agent 104c may be communicatively coupled to the storage agent 104b and/or the storage agent 104a using an unreliable or intermittent connection. The storage network manager 114 may accordingly communicate with the storage agent 104c via the communication network 112, and may then relay data from the storage agent 104c to the storage agent 104b and/or the storage agent 104a.

Accordingly, the storage system 100 and storage network 102 may be configured to facilitate the management of data that may be stored on the storage network 102 such that the data may be accessed by any number of devices 106 associated with the storage network 102. Modifications, additions, or omissions may be made to the storage system 100 without departing from the scope of the present disclosure. For example, the storage system 100 may include any number of devices 106, storage blocks 110 and/or storage agents 104. Further, the location of components within the devices 106 and the storage agents 104 is for illustrative purposes only and is not limiting. Additionally, although certain functions are described as being performed by certain devices, the principles and teachings described herein may be applied in and by any suitable element of any applicable storage network and/or storage system.

As indicated above, in some instances, one or more of the devices of a storage network may include a camera and the data stored on the storage network may include image files created by the device and its associated camera. As detailed below with respect to FIG. 2, in some embodiments, a device that includes a camera may include a particular type of storage agent referred to as a “capture agent” that may be configured to integrate the device and its associated camera with a storage network.

FIG. 2 illustrates an example electronic device 206 (referred to hereinafter as “device 206”) that includes a camera 230 and that may be integrated with a storage network, according to some embodiments described herein. The device 206 may be configured to generate image files such as video or photo files and in some embodiments may have a myriad of other functionality. For example, in some embodiments, the device 206 may be a smartphone or tablet device. In other embodiments, the device 206 may be configured as a standalone camera configured to generate image files.

The device 206 may include a controller 220, a communication module 216, a camera 230, a microphone 232, a GPS sensor 234, a motion sensor 236, sensor(s) 238, and/or a user interface 240. The controller 220 may be configured to perform operations associated with the device 206 and may include a processor 250, memory 252, and a storage block 210 analogous to the processors 150, memories 152, and storage blocks 110 of FIG. 1. The controller 220 may also include a capture agent 204 that may act as a storage agent for the device 206. As detailed below, the capture agent 204 may be configured to integrate the device 206 with the storage network with respect to operations of the camera 230 of the device 206. The communication module 216 may be analogous to the communication modules 116 of FIG. 1 and may be configured to provide connectivity (e.g., wired or wireless) of the device 206 with a storage network and/or a communication network.

The camera 230 may include any camera known in the art that captures photographs and/or records digital video of any aspect ratio, size, and/or frame rate. The camera 230 may include an image sensor that samples and records a field of view. The image sensor, for example, may include a charge-coupled device (CCD) or a complementary metal-oxide semiconductor (CMOS) sensor. The camera 230 may provide raw or compressed image data, which may be stored by the controller 220 on the storage block 210 as image files. The image data provided by camera 230 may include still image data (e.g., photographs) and/or a series of frames linked together in time as video data.

The microphone 232 may include one or more microphones for collecting audio. The audio may be recorded as mono, stereo, surround sound (any number of channels), Dolby, etc., or any other audio format. Moreover, the audio may be compressed, encoded, filtered, compressed, etc. The controller 220 may be configured to store the audio data to the storage block 210. In some embodiments, the audio data may be synchronized with associated video data and stored and saved within an image file of a video. In these or other embodiments, the audio data may be stored and saved as a separate audio file. The audio data may also, for example, include any number of tracks. For example, for stereo audio, two tracks may be used. And, for example, surround sound 5.1 audio may include six tracks. Additionally, in some embodiments, the capture agent 204 may be configured to generate metadata based on the audio data as explained in further detail below.

The controller 220 may be communicatively coupled with the camera 230 and the microphone 232 and/or may control the operation of the camera 230 and the microphone 232. The controller 220 may also perform various types of processing, filtering, compression, etc. of image data, video data and/or audio data prior to storing the image data, video data and/or audio data into the storage block 210 as image files.

The GPS sensor 234 may be communicatively coupled with the controller 220. The GPS sensor 234 may include a sensor that may collect GPS data. Any type of the GPS sensor may be used. GPS data may include, for example, the latitude, the longitude, the altitude, a time of the fix with the satellites, a number representing the number of satellites used to determine GPS data, the bearing, and speed.

In some embodiments, the capture agent 204 may be configured to direct the GPS sensor 234 to sample the GPS data when the camera 230 is capturing the image data. The GPS data may then be included in metadata that may be generated for the associated image files and stored in the storage block 210. In some embodiments, during the creation of video data, the capture agent 204 may direct the GPS sensor 234 to sample and record the GPS data at the same frame rate as the camera 230 records video frames and the GPS data may be saved as metadata at the same rate. For example, if the video data is recorded at 24 fps, then the GPS sensor 234 may sample the GPS data 24 times a second, which may also be stored 24 times a second.

The motion sensor 236 may be communicatively coupled with the controller 220. In some embodiments, the capture agent 204 may be configured to direct the motion sensor 236 to sample the motion data when the camera 230 is capturing the image data. The motion data may then be included in metadata that may be generated for the associated image files and stored in the storage block 210. In some embodiments, e.g., during the creation of video data, the capture agent 204 may direct the motion sensor 236 to sample and record the motion data at the same frame rate as the camera 230 records video frames and the motion data may be saved as metadata at the same rate. For example, if the video data is recorded at 24 fps, then the motion sensor 236 may sample the motion data 24 times a second, which may also be stored 24 times a second.

The motion sensor 236 may include, for example, an accelerometer, gyroscope, and/or a magnetometer. The motion sensor 236 may include, for example, a nine-axis sensor that outputs raw data in three axes for each individual sensor: acceleration, gyroscope, and magnetometer, or it may be configured to output a rotation matrix that describes the rotation of the sensor about the three Cartesian axes. Moreover, the motion sensor 236 may also provide acceleration data. Alternatively, the motion sensor 236 may include separate sensors such as a separate one-three axis accelerometer, a gyroscope, and/or a magnetometer. The motion data may be raw or processed data from the motion sensor 236.

The sensor(s) 238 may include any number of additional sensors such as, for example, an ambient light sensor, a thermometer, barometric pressure sensor, heart rate sensor, other biological sensors, etc. The sensor(s) 238 may be communicatively coupled with the controller 220. In some embodiments, the capture agent 204 may be configured to direct the sensor(s) 238 to sample their respective data when the camera 230 is capturing the image data. The respective data may then be included in metadata that may be generated for the associated image files and stored in the storage block 210.

The user interface 240 may include any type of input/output device including buttons and/or a touchscreen. The user interface 240 may be communicatively coupled with the controller 220 via a wired or wireless interface. The user interface may provide instructions to the controller 220 from the user and/or output data to the user. Various user inputs may be saved in the memory 252 and/or the storage block 210. For example, the user may input a title, a location name, the names of individuals, etc. of a video being recorded. Data sampled from various other devices or from other inputs may be saved into the memory 252 and/or the storage block 210. In some embodiments, the capture agent 204 may include the data received from the user interface 240 and/or the various other devices with metadata generated for image files.

As indicated above, in some embodiments, the capture agent 204 may be configured to generate metadata for image files generated by the device 206 based on the GPS data, the motion data, the data from the sensor(s) 238, the audio data, and/or data received from the user interface 240. For example, the motion data may be used to generate metadata that indicates positioning of the device 206 during the generation of one or more image files. As another example, geolocation data associated with the image files, e.g., location of where the images were captured, speed, acceleration, etc., may be derived from the GPS data and included in metadata associated with the image files.

As another example, voice tagging data associated with the image files may be derived from the audio data and may be included in the corresponding metadata. The voice tagging data may include voice initiated tags according to some embodiments described herein. Voice tagging may occur in real time during recording or during post processing. In some embodiments, voice tagging may identify selected words spoken and recorded through the microphone 232 and may save text identifying such words as being spoken during an associated frame of a video image file. For example, voice tagging may identify the spoken word “Go!” as being associated with the start of action (e.g., the start of a race) that will be recorded in upcoming video frames. As another example, voice tagging may identify the spoken word “Wow!” as identifying an interesting event that is being recorded in the video frame or frames. Any number of words may be tagged in the voice tagging data that may be included in the metadata. In some embodiments, the capture agent 204 may transcribe all spoken words into text and the text may be saved as part of the metadata.

Motion data associated with the image files may also be included in the metadata. The motion data may include data indicating various motion-related data such as, for example, acceleration data, velocity data, speed data, zooming out data, zooming in data, etc. that may be associated with the image files. Some motion data may be derived, for example, from data sampled from the motion sensor 236, the GPS sensor 234 and/or from the geolocation data. Certain accelerations or changes in acceleration that occur in a video frame or a series of video frames (e.g., changes in motion data above a specified threshold) may result in the video frame or the video frames being tagged to indicate the occurrence of certain events of the camera such as, for example, rotations, drops, stops, starts, beginning action, bumps, jerks, etc. The motion data may be derived from tagging such events, which may be performed by the capture agent 204 in real time or during post processing.

Further, orientation data associated with the image files may be included in the metadata. The orientation data may indicate the orientation of the electronic device 206 when the image files are captured. The orientation data may be derived from the motion sensor 236 in some embodiments. For example, the orientation data may be derived from the motion sensor 236 when the motion sensor 236 is a gyroscope.

Additionally, people data associated with the image files may be included in corresponding metadata. The people data may include data that indicates the names of people within an image file as well as rectangle information that represents the approximate location of the person (or person's face) within the video frame. The people data may be derived from information input by the user on the user interface 240 as well as other processing that may be performed by the device 206.

The metadata may also include user tag data associated with image files. The user tag data may include any suitable form of indication of interest of an image file that may be provided by the user. For example, the user tag data for a particular image file may include a tag indicating that the user has “starred” the particular image file, thus indicating a prioritization by the user of the particular image file. In some embodiments, the user tag data may be received via the user interface 240.

The metadata may also include data associated with the image files that may be derived from the other sensor(s) 238. For example, the other sensor(s) 238 may include a heart rate monitor and the metadata for an image file may include biological data indicating the heart rate of a user when the associated image or video is captured. As another example, the other sensor(s) may include a thermometer and the metadata for an image file may include the ambient temperature when the associated image or video is captured.

Other examples of metadata that may be associated with the image files may include time stamps and date stamps indicating the time and date of when the associated images or videos are captured. The time stamps and date stamps may be derived from time and date data provided by the user via the user interface 240, or determined by the capture agent 204 as described below.

Further, in some embodiments, the capture agent 204 may be configured to generate unique fingerprints for the image files, which may be included in associated metadata. The fingerprints may be derived from uniquely identifying content included in the image files that may be used to identify the image files. Therefore, image files that include the same content but that may be given different file names or the like, may include the same unique fingerprint such that they may identified as being the same. In some embodiments, the unique fingerprints may be generated using a cyclic redundancy check (CRC) algorithm or a secure hash algorithm (SHA) such as a SHA-256.

The metadata (e.g., geolocation data, voice tag data, motion data, geolocation data, audio data, voice tag data, motion data, biological data, temperature data, time stamp, date stamp, user tag data, barometric pressure data, people data, and/or a fingerprint data) may be stored and configured according to any suitable data structure associated with the image files. For example, for still image files (e.g., photographs) the metadata may be stored according to any suitable still image standard. As another example, for video image files, the metadata may be stored as described in U.S. patent application Ser. No. 14/143,335, entitled “VIDEO METADATA” and filed on Dec. 30, 2013, the entire contents of which are incorporated by reference herein.

The metadata generated from the geolocation data, voice tag data, motion data, people data, temperature data, time stamp data, date stamp data, biological data, user tag data, and/or fingerprint data may be used by the storage network to classify, sort, allocate, distribute etc., the associated image files throughout the storage network. For example, image files may be sorted according to where the associated images were captured, who is in the images, similar motion data (indicating similar activities) or the like based on the metadata. Accordingly, the capture agent 204 may be configured to generate metadata for the image files generated by the device 206 in a manner that facilitates integration of the image files (and consequently the device 206) in an storage network.

The capture agent 204 may also be configured to direct operations of the device 206 in a manner that may improve efficiency of the device 206. For example, in some embodiments, the capture agent 204 may be configured to direct the transfer of image files and associated metadata generated by the device 206 to the storage network (e.g., to one or more other devices of the storage network) based on a status of the device 206 that may affect the efficiency of the device 206. The status of the device 206 may include one or more of power consumption associated with transferring the image files and metadata, battery status of a battery 242 of the device 206, available storage space on the device 206 (e.g., available storage space on the storage block 210), available network connectivity paths of the device 206, and a power supply mode of the device 206. In these or other embodiments, the capture agent 204 may similarly enable or disable connectivity of the device 206 to the storage network (e.g., connectivity to one or more other devices of the storage network and/or to the storage network manager of the storage network) and/or a communication network (e.g., the network 112 of FIG. 1)—which may enable connectivity to the storage network—based on the status of the device 206. The status may include one or more of power consumption associated with enabling and maintaining the connectivity, battery status, available storage space on the device 206, and a power supply mode of the device 206.

By way of example, transferring data, such as image files, may consume a substantial amount of power. Therefore, the capture agent 204 may monitor the status of the battery 242 to determine whether or not to transfer the image files. Similarly, establishing and/or maintaining connectivity with the storage network and/or a communication network that may enable connectivity with the storage network may consume power. For example, searching for, establishing and/or maintaining a wireless (e.g., WiFi) connection with another device of the storage network or a communication network that may facilitate communication with another device of the storage network may consume a significant amount of power. Accordingly, in some embodiments, the capture agent 204 may determine whether or not to look for or establish a wireless connection that may enable the transfer of image files based on the amount of charge left in the battery 242 and a determined amount of power consumption that may be related to transferring the image files. Similarly, the capture agent 204 may determine whether or not to disconnect or maintain connectivity based on the amount of charge left in the battery 242.

In some embodiments, the decision of whether or not to transfer the image files may be based on a threshold amount of charge left in the battery 242. The threshold associated with the battery 242 may be a set amount or may be determined based on prior energy consumption of the battery 242. For example, although a significant amount of charge may be left in the battery 242, the recent past energy consumption of the battery 242 may indicate a high degree of consumption, which may indicate a relatively high probability of high energy consumption in the future. Accordingly, the capture agent 204 may set a higher threshold to allow for a potentially high energy consumption.

As another example, the amount of available storage space for the image files may indicate an amount of additional image files that may be generated. Accordingly, the capture agent 204 may determine whether or not to transfer the image files based on how much available storage space there may be for additional image files. As such, battery power may be conserved by not transferring image files if a certain amount of storage space available on the device 206. Similarly, the capture agent 204 may determine whether or not to connect the device 206 with the storage network and/or communication network, disconnect the device 206 from the storage network and/or communication network, and/or maintain connectivity with the storage network and/or communication network based on the amount of available storage space. Additionally, in some embodiments, once a transfer of image files is complete, the capture agent 204 may be configured to disconnect the device 206 from the storage network and/or communication network to help preserve battery life.

In some embodiments, the capture agent 204 may be configured to direct the transfer of the image files when the amount of available storage space decreases below a certain threshold. The threshold may be a predetermined amount of storage space, may be based on an average or median size of currently stored image files, may be based on an average or median size of recently created image files, may be based on a predominant and/or average file type used, or any other metric. For example, in some instances, a user of the device 206 may capture a lot of video of a certain file type, such that the threshold may be based on video image files of the certain file type. As another example, the user may capture a lot of photos that are compressed such that the threshold may be based on still image files of the compressed file type.

Further, in some embodiments, the capture agent 204 may be configured to determine whether or not to transfer the image files to the associate storage network based on a power supply mode of the device 206. For example, the device 206 may include the battery 242 as well as an external power interface 244. The external power interface 244 may be configured to supply power to the device 206 via an associated cable when the associated cable is plugged into an external power source such as an outlet or a port (e.g., USB port) of another device. Accordingly, the device 206 may have a power supply mode associated with the battery 242 providing power to the device 206 or associated with the device 206 receiving power from an external source via the external power interface 244. In some embodiments, the capture agent 204 may direct the transfer of image files to the storage network when the power supply mode of the device 206 is associated with the device 206 receiving power from an external source via the external power interface 244 because reduced power consumption may be a lower priority when the device 206 is in this power supply mode.

Similarly, in these or other embodiments, the capture agent 204 may determine whether or not to connect the device 206 with the storage network and/or the communication network, disconnect the device 206 from the storage network and/or the communication network, and/or maintain connectivity with the storage network and/or the communication network based on the power supply mode. For example, when the device 206 is powered via the external power interface 244 and an external power source, the capture agent 204 may establish and maintain connectivity with the storage network and/or communication network. In some embodiments, the maintained connectivity may allow the capture agent 204 to receive instructions from a storage network manager (e.g., the storage network manager 114 of FIG. 1) of the storage network.

In these or other embodiments, the capture agent 204 may determine which image files to transfer first based on a prioritization of the image files. The prioritization may be based on file size, file type, etc. The prioritization may be determined locally by the capture agent 204 and/or by the storage network manager of the storage network.

Additionally, in some embodiments, the capture agent 204 may be configured to transfer the image files in batches to conserve energy. Transferring files in batches instead of one at a time may consume less energy such that more battery power may be conserved.

In some embodiments, the capture agent 204 may determine whether or not to transfer the image files, establish connectivity and/or maintain connectivity based on any combination of the above discussed factors. For example, in some instances the amount of charge left in the battery 242 may be below the associated threshold, but the device 206 may be connected to an external power supply via the external power interface. In some embodiments, in this instance, the capture agent 204 may direct that image files be transferred and/or connectivity be established and/or maintained.

As another example, in some embodiments, the amount of available storage space may be above the associated threshold but based on the battery status (e.g., a relatively large amount of charge remaining) and/or the power supply mode (e.g., an external power supply mode), the capture agent 204 may direct that the image files be transferred. As another example, when the amount of charge in the battery is lower than the associated threshold and the amount of available storage space is also lower than the associated threshold, the capture agent 204 may determine to conserve battery power by not transferring image files in some embodiments and in other embodiments may determine to free up storage space by transferring image files. In some embodiments, the determination may be based on an indicated user preference.

The capture agent 204 may also be configured to direct the deletion of image files and associated metadata from the device 206 that have been transferred to the storage network to free up storage space on the device 206 (e.g., on the storage block 210). In some embodiments, the capture agent 204 may direct the deletion of the image files upon receiving instructions from the storage network manager or an indication from the storage network manager that the image files have been successfully transferred to the storage network. The capture agent 204 may also be configured to perform other operations associated with integrating the device 206 in the storage network. For example, the capture agent 204 may be configured to register and authenticate the device 206 with the storage network. Based on information received from the storage network and/or a communication network, the capture agent 204 may also be configured to perform general set up operations for the device 206. For example, the capture agent 204 may be configured to set the date and time for the device 206.

The capture agent 204 may also be configured to determine whether or not to transfer data files and/or maintain connectivity with the storage network based on available connectivity paths with the storage network. For example, in some embodiments, the device 206 may be connected to the storage network (e.g., connected to another device of the storage network) via a wired connection (e.g., a USB connection). The wired connection may allow for significantly less power consumption for transferring image files and/or maintaining connectivity with the storage network than a wireless connection. Accordingly, the capture agent 204 may consider the connectivity path with the storage network in determining whether or not to transfer the image files and/or maintain the connectivity.

As another example, in some embodiments, the network connectivity path may include a WiFi connection or a cellular service connection. The WiFi connection may allow for transfers of data files without incurring extra monetary cost, whereas the transfer of image files via the cellular service connection may cost the user money. As another example, the WiFi connection or the cellular service connection may be faster than the other connection. Accordingly, the capture agent 204 may determine these different factors associated with the WiFi connection and the cellular service connection in determining which connectivity path to use for transferring the image files to the storage network.

Accordingly, the capture agent 204 may be configured to intelligently integrate the device 206 and its operations associated with the camera 230. Modifications, additions, or omissions may be made to the device 206 without departing from the scope of the present disclosure. For example, the device 206 may include other elements than those explicitly illustrated. Additionally, the device 206 and/or any of the other listed elements of the device 206 may perform other operations than those explicitly described.

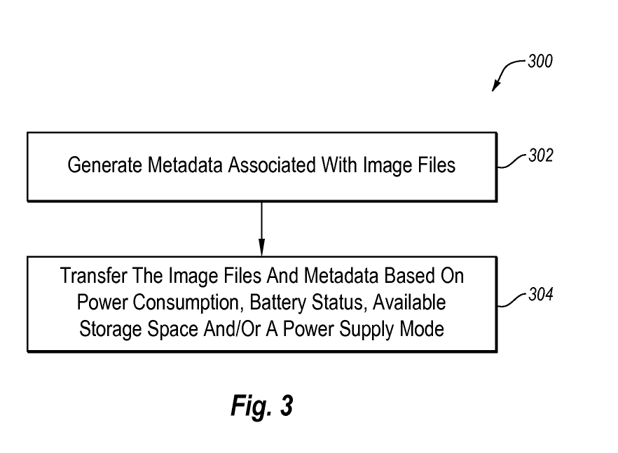

FIG. 3 is a flowchart of an example method 300 of integrating a device with a storage network, according to at least one embodiment described herein. One or more steps of the method 300 may be implemented, in some embodiments, by the capture agent 204 of FIG. 2. Although illustrated as discrete blocks, various blocks may be divided into additional blocks, combined into fewer blocks, or eliminated, depending on the desired implementation.

The method 300 may begin at block 302, where metadata associated with image files of a camera of a device may be generated. The image files may be video image files and/or still image files. Additionally, the metadata may include geolocation data, audio data, device orientation data, a fingerprint uniquely identifying the image files, voice tag data, motion data, biological data, temperature data, time stamp, date stamp, user tag data, barometric pressure data, and people data, as described above.

At block 304, the image files and the metadata may be automatically transferred to a storage network based on one or more of power consumption associated with transferring the image files and metadata, battery status of a battery of the device, available storage space on the device, and a power supply mode of the device.

Accordingly, the method 300 may be performed to integrate the device and image files with a storage network. One skilled in the art will appreciate that, for the method 300 and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, in some embodiments, the method 300 may include steps associated with enabling connectivity with, maintaining connectivity with, or disabling connectivity with the storage network and/or a communication network that may enable connectivity to the storage network based on of power consumption associated with enabling and/or maintaining the connectivity, battery status, available storage space on the device, and a power supply mode of the device. Additionally, in some embodiments, the method 300 may include automatically deleting image files and metadata stored on the device that have been transferred to the storage network.

As described above, the embodiments described herein may include the use of a special purpose or general purpose computer (e.g., the processors 150 of FIG. 1) including various computer hardware or software modules, as discussed in greater detail below. The special purpose or general purpose computer may be configured to execute computer-executable instructions stored on computer-readable media (e.g., the memories 152 and/or storage blocks 110 of FIG. 1).

Computer-executable instructions may include, for example, instructions and data which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the present disclosure.

What is claimed is:

1. A method of integrating a device with a storage network, the method comprising:
generating metadata associated with image files generated by a camera of a device;
automatically transferring to a storage network the image files and the metadata based on one or more of power consumption associated with transferring the image files and metadata, battery status of a battery of the device, available storage space on the device, available connectivity paths with the storage network, and a power supply mode of the device.

2. The method of claim 1, wherein the image files include one or more of still image files and video files.

3. The method of claim 1, wherein the metadata includes one or more of: geolocation data, audio data, device orientation data, a fingerprint uniquely identifying the image files, voice tag data, motion data, biological data, temperature data, time stamp, date stamp, user tag data, barometric pressure data, and people data.

4. The method of claim 1, further comprising enabling connectivity of the device to one or more of the storage network and a communication network based on one or more of: power consumption associated with enabling and maintaining the connectivity, battery status, available storage space on the device, available network connectivity paths, and a power supply mode of the device.

5. The method of claim 4, wherein the communication network enables connectivity to the storage network.

6. The method of claim 4, further comprising automatically disconnecting the device from one or more of the communication network and the storage network based on one or more of power consumption associated with maintaining connectivity to one or more of the storage network and the communication network, battery status, available storage space on the device, and a power supply mode of the device.

7. The method of claim 1, further comprising automatically deleting image files and metadata stored on the device that have been transferred to the storage network.

8. The method of claim 1, further comprising transferring the image files in batches to conserve energy.

9. An electronic device comprising:
a camera configured to generate image data;
a processor; and
memory including instructions configured to cause the processor to perform operations for integrating the electronic device with a storage network, the operations comprising:
generating metadata associated with image files generated from the image data;
automatically transferring to a storage network the image files and the metadata based on one or more of power consumption associated with transferring the image files and metadata, battery status of a battery of the device, available storage space on the device, available connectivity paths with the storage network, and a power supply mode of the device.

10. The electronic device of claim 9, wherein the image data includes one or more of still image data and video data and wherein the image files include one or more of still image files and video files.

11. The electronic device of claim 9, wherein the electronic device includes one or more of a microphone, a global positioning system (GPS) sensor, a motion sensor, a biological sensor, a thermometer, a barometric pressure sensor, and a user interface and wherein the metadata includes data derived from one or more of the microphone, the GPS sensor, the motion sensor, the biological sensor, the thermometer, the barometric pressure sensor, and the user interface.

12. The electronic device of claim 9, wherein the metadata includes one or more of: geolocation data, audio data, device orientation data, a fingerprint uniquely identifying the image files, voice tag data, motion data, biological data, temperature data, time stamp, date stamp, user tag data, barometric pressure data, and people data.

13. The electronic device of claim 9, wherein the operations further comprise enabling connectivity of the device to one or more of a communication network and the storage network based on one or more of power consumption associated with enabling and maintaining the connectivity, battery status, available storage space on the device, available network connectivity paths, and a power supply mode of the device.

14. The electronic device of claim 13, wherein the communication network enables connectivity to the storage network.

15. The electronic device of claim 13, wherein the operations further comprise automatically disconnecting the device from one or more of the communication network and the storage network based on one or more of power consumption associated with maintaining connectivity to one or more of the storage network and the communication network, battery status, available storage space on the device, and a power supply mode of the device.

16. The electronic device of claim 9, wherein the device includes a storage block configured to store the image files and the metadata and the operations further comprise automatically deleting image files and metadata stored on the storage block that have been transferred to the storage network.

17. A computer-readable storage medium configured to store instructions configured to cause a processor to perform operations for integrating an electronic device with a storage network, the operations comprising:
generating metadata associated with image files generated by a camera of a device;
automatically transferring to a storage network the image files and the metadata based on one or more of power consumption associated with transferring the image files and metadata, battery status of a battery of the device, available storage space on the device, available connectivity paths with the storage network, and a power supply mode of the device.

18. The computer-readable storage medium of claim 17, wherein the image files include one or more of still image files and video files.

19. The computer-readable storage medium of claim 17, wherein the metadata includes one or more of: geolocation data, audio data, device orientation data, a fingerprint uniquely identifying the image files, voice tag data, motion data, biological data, temperature data, time stamp, date stamp, user tag data, barometric pressure data, and people data.

20. The computer-readable storage medium of claim 17, wherein the operations further comprise enabling connectivity of the device to one or more of the storage network and a communication network based on one or more of power consumption associated with enabling and maintaining the connectivity, battery status, available storage space on the device, available network connectivity paths, and a power supply mode of the device.
